(19) United States
(12) Patent Application Publication
(10) Pub. No.: US 2017/0182674 A1
(43) Pub. Date: Jun. 29, 2017

(54) CUT DATA GENERATING APPARATUS, CUTTING APPARATUS, AND CUT DATA GENERATING PROGRAM

(71) Applicant: BROTHER KOGYO KABUSHIKI KAISHA, Nagoya (JP)

(72) Inventor: Yukiyoshi Muto, Nagoya (JP)

(21) Appl. No.: 15/456,106

(22) Filed: Mar. 10, 2017

Related U.S. Application Data
(63) Continuation of application No. PCT/JP2015/080185, filed on Oct. 27, 2015.

(30) Foreign Application Priority Data
Oct. 29, 2014 (JP) 2014-220250

(51) Int. Cl. B26D 5/00; B26F 1/38; B26D 7/26

(52) U.S. Cl. CPC B26D 5/005; B26D 7/2614; B26F 1/3806

(57) ABSTRACT

A cut data generating apparatus configured to generate cut data for a cutting apparatus to cut multiple holes from a sheet material includes a controller being configured to control the cut data generating apparatus to: extract, as a first feature point and a second feature point, end points on opposite ends of one line in a figure expressed by one or more lines with finite lengths; set third feature points on the one line between the first feature point and the second feature point; place a hole on each position of the first feature point, the second feature point, and the third feature points; and generate cut data for cutting the placed holes.

### CROSS-REFERENCE TO RELATED APPLICATION

This application is a continuation application of International Application No. PCT/JP2015/080185, filed on Oct. 27, 2015, which claims priority from Japanese Patent Application No. 2014-220250, filed on Oct. 29, 2014. The disclosure of the foregoing application is hereby incorporated by reference in its entirety.

### FIELD

The disclosure relates to a cut data generating apparatus, a cutting apparatus, and a cut data generating program for generating cut data for the cutting apparatus to cut multiple holes for placing decorative parts from a sheet material.

### BACKGROUND

Conventionally, small granular decorative parts, such as imitation gems called rhinestone, are used to decorate clothing or small goods. A large number of rhinestones are placed in a desired pattern shape on the surface of the clothing or small goods, and the rhinestones are fixed by adhesion. A method of placing multiple rhinestones along a Bezier curve is proposed. In the placement method, anchor points of the Bezier curve and points determined based on the anchor points are set as specified points, and the specified points are set as placement points for placing the rhinestones.

A configuration is also described, in which after the placement points are determined, a processing machine processes a mold of a cardboard to form holes for placing the rhinestones on the mold.

### SUMMARY

The user can, for example, generate a desired figure based on the Bezier curve and use the placement method to determine the placement points for placing the rhinestones. However, the placement points for placing the rhinestones may not be the positions desired by the user, depending on the shape of the figure. The reason is that the placement points for placing the rhinestones are determined based only on the anchor points of the Bezier curve. Therefore, even when the conventional placement method is used to form holes on the mold, and multiple rhinestones are placed on the holes to express the figure, the features of the figure desired by the user may not be sufficiently expressed.

In view of the circumstances, an object of the disclosure is to provide a cut data generating apparatus, a cutting apparatus, and a cut data generating program capable of generating cut data for cutting multiple holes for placing rhinestones from a sheet material, the cut data indicating locations of the holes that can sufficiently express features of a figure.

To attain the object, a first aspect of the disclosure provides a cut data generating apparatus configured to generate cut data for a cutting apparatus to cut multiple holes from a sheet material, the cut data generating apparatus including: a controller being configured to control the cut data generating apparatus to: extract, as a first feature point and a second feature point, end points on opposite ends of one line in a figure expressed by one or more lines with finite lengths; set third feature points on the one line between the first feature point and the second feature point; place a hole on each position of the first feature point, the second feature point, and the third feature points; and generate cut data for cutting the placed holes.

The “lines” in the disclosure denote lines that form the figure and denote lines including end points on opposite ends. The lines include straight lines, curved lines, and bent lines. In other words, the “lines” in the disclosure denote lines that can be depicted with a single stroke. The “figure” in the disclosure denotes a figure in a shape expressed by one or multiple lines.

An eighth aspect of the disclosure provides a cutting apparatus including the cut data generating apparatus.

A ninth aspect of the disclosure provides a cut data generating program recorded in a recording medium, the cut data generating program causing a computer to function as various processing units of the cut data generating apparatus.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 is a perspective view illustrating an embodiment of the disclosure, schematically illustrating appearances of a cutting apparatus and a cut data generating apparatus.

FIG. 2 is a block diagram illustrating electrical structures of the cutting apparatus and the cut data generating apparatus.

FIG. 3 is a flowchart illustrating an overall procedure of a process of determining positions of holes.

FIG. 4 is a flowchart illustrating a procedure of setting the positions of the holes for one target line.

FIG. 5 is a flowchart illustrating a procedure of setting the positions of the holes between feature points.

FIG. 6 illustrates an example of a figure.

FIG. 7 illustrates the figure separated into two lines.

FIG. 8 illustrates feature points set in each line.

FIG. 9 illustrates locations of the holes.

FIG. 10 is a diagram for explaining a method of setting third feature points.

FIG. 11 is a diagram for explaining a method of judging an angle of a corner.

FIG. 12 is a diagram equivalent to FIG. 8, illustrating another embodiment of the disclosure.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

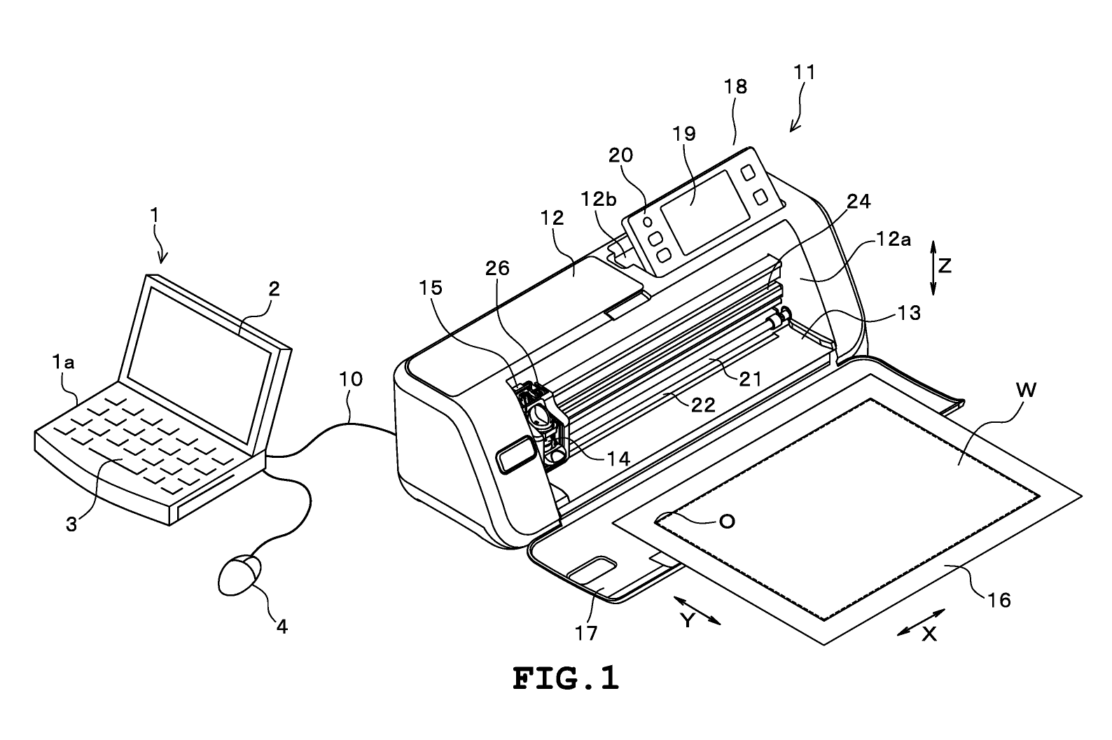

An embodiment of the disclosure will now be described with reference to FIGS. 1 to 11. FIG. 1 illustrates external structures of a cut data generating apparatus 1 and a cutting apparatus 11 according to the present embodiment.

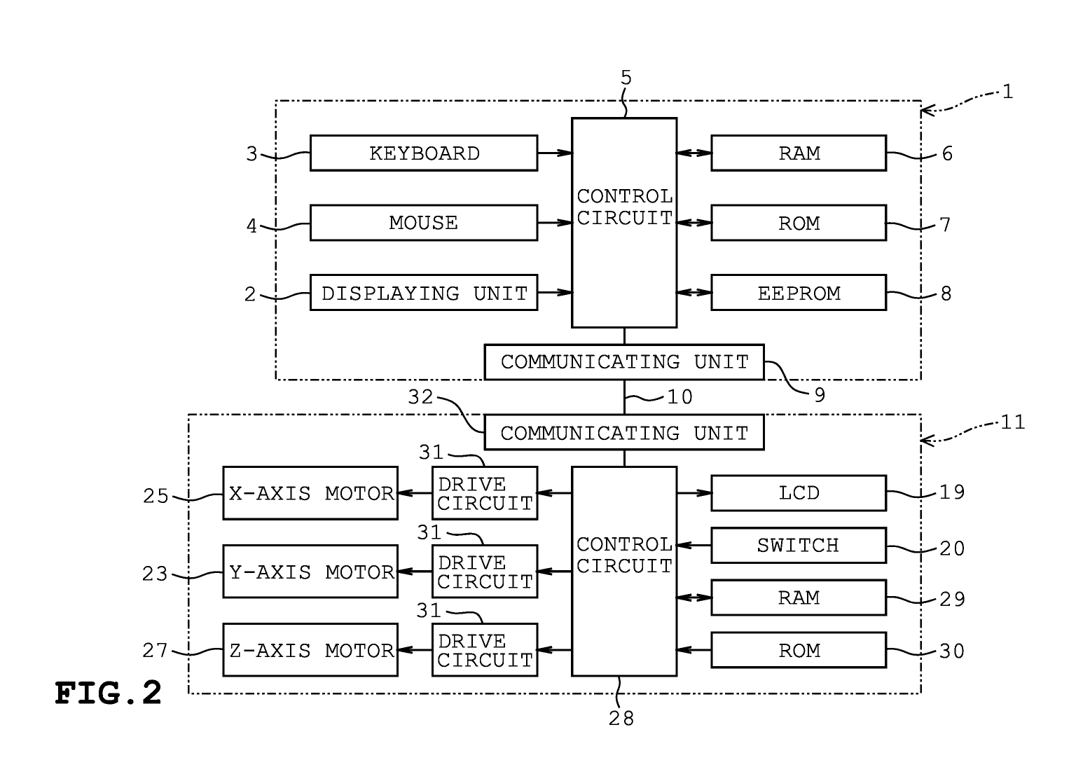

FIG. 2 schematically illustrates electrical structures of the cut data generating apparatus 1 and the cutting apparatus 11. The cut data generating apparatus 1 according to the present embodiment is comprised of, for example, a personal computer and is connected to the cutting apparatus 11 through a communication cable 10. The cut data generating apparatus 1 will be described later. The cutting apparatus 11 is an apparatus configured to automatically cut a workpiece, such as paper and sheet, according to cut data.

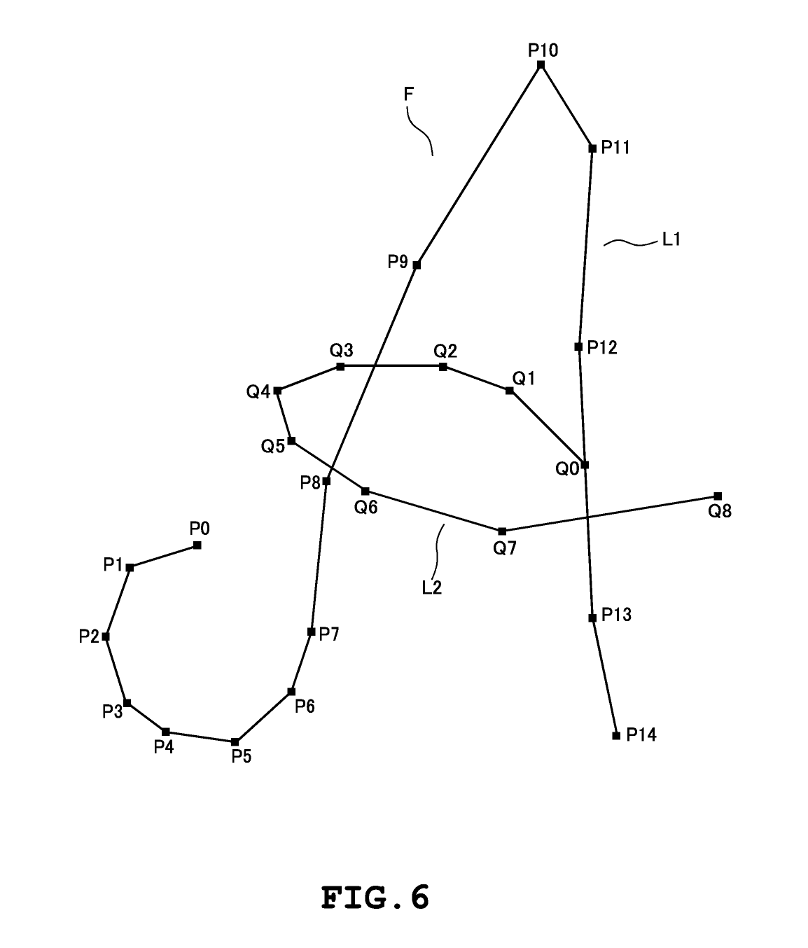

Although not illustrated in detail, the present embodiment describes an example in which the cutting apparatus 11 produces a pattern sheet by cutting multiple holes H (see FIG. 6 etc.) for placing decorative parts called rhinestone, on a sheet material W (see FIG. 1) made of, for example, paper or plastic. A large number of rhinestones are placed in a desired pattern shape on the surface of clothing or small goods, and the rhinestones are fixed by adhesion. The pattern sheet is used by the user to place multiple rhinestones in a desired pattern shape.

The cutting apparatus 11 will be described first with reference to FIGS. 1 and 2. As illustrated in FIG. 1, the cutting apparatus 11 is provided with a body cover 12, a platen 13 disposed in the body cover 12, and a cut head 15 including a cutter cartridge 14. The cutting apparatus 11 is provided with a holding member 16 for holding the sheet material W as a workpiece. The holding member 16 is provided with a base shaped like a rectangular thin plate as a whole and an adhesive layer provided on the upper surface of the base. The adhesive layer holds the sheet material W in a manner that the sheet material W can be peeled.

The body cover 12 is shaped like a laterally elongated rectangular box with the front surface slightly slanted downward, and a front opening 12a that opens laterally is formed on a front surface portion. A front cover 17 for opening and closing the front opening 12a is rotatably provided on a lower side portion of the front surface of the body cover 12. The holding member 16 is inserted into the cutting apparatus 11 from the front with the front cover 17 opened and is set on the upper surface of the platen 13. The upper surface of the platen 13 is a horizontal plane. The holding member 16 is mounted on the upper surface of the platen 13, and the holding member 16 is fed in a forward and rearward direction (Y direction).

An operation panel 18 is provided on a right side portion of the upper surface of the body cover 12. The operation panel 18 is provided with a liquid crystal display (LCD) 19 and multiple switches 20 for operation of various instructions, selection, or input by the user. The multiple switches 20 also include a touch panel provided on the surface of the display 19.

A feed mechanism configured to feed the holding member 16 in the forward and rearward direction (Y direction) on the upper surface of the platen 13 is provided in the body cover 12. A cutter transfer mechanism configured to move the cut head 15 (carriage) in a left and right direction (X direction) is further provided. The directions in the present embodiment will be defined here. The feed direction of the holding member 16 fed by the feed mechanism is the forward and rearward direction (Y direction). The movement direction of the cut head 15 moved by the cutter transfer mechanism is the left and right direction (X direction). A direction orthogonal to the forward and rearward direction and the left and right direction is an up and down direction (Z direction).

The feed mechanism will be described. A pinch roller 21 and a drive roller 22 extending in the left and right direction are aligned up and down and provided in the body cover 12. Left and right edges of the holding member 16 are held between the pinch roller 21 and the drive roller 22 and the holding member 16 is fed in the forward and rearward direction. Although not illustrated in detail, a Y-axis motor 23 (illustrated only in FIG. 2) and a gear mechanism configured to transmit the rotation of the Y-axis motor 23 to the drive roller 22 are provided on a right side portion in the body cover 12. In this way, the Y-axis motor 23 rotates the drive roller 22, and the feed mechanism feeds the holding member 16 in the forward and rearward direction.

Next, the cutter transfer mechanism will be described. A guide rail 24 positioned on the rear side and above the pinch roller 21 and extending in the left and right direction is disposed in the body cover 12. The cut head 15 is supported by the guide rail 24 in a manner that the cut head 15 can move in the left and right direction. Although not illustrated in detail, an X-axis motor 25 (illustrated only in FIG. 2) and a drive pulley rotated by the X-axis motor 25 are provided on a left side portion in the body cover 12.

On the other hand, a follower pulley is provided on the right side portion in the body cover 12, although not illustrated. An endless timing belt which extends in the left and right direction is horizontally wound between the drive pulley and the follower pulley. An intermediate portion of the timing belt is connected to the cut head 15. In this way, the rotation of the X-axis motor 25 in the cutter transfer mechanism moves the cut head 15 in the left and right direction via the timing belt.

The cut head 15 is provided with a cartridge holder 26 and an up-down drive mechanism configured to drive the cartridge holder 26 in the up and down direction. The cartridge holder 26 holds the cutter cartridge 14 in a manner that the cutter cartridge 14 can be attached and detached. Although not illustrated, the cutter cartridge 14 is provided with a cutter along a central axis extending in the up and down direction of a case shaped like a cylinder. A blade portion is formed on a lower end of the cutter. The cutter cartridge 14 holds the cutter at a position where the blade portion slightly protrudes from a lower end portion of the case.

The up-down drive mechanism is provided with a Z-axis motor 27 (illustrated only in FIG. 2) etc. and is configured to move the cutter cartridge 14 between a lowered position where the blade portion of the cutter cuts the workpiece and a lifted position where the blade portion of the cutter is spaced apart by a predetermined distance upward from the workpiece. The cutter cartridge 14 is located at the lifted position at normal times, i.e. when the cutting operation is not performed, and the up-down drive mechanism moves the cutter cartridge 14 to the lowered position during the cutting operation.

As a result, the blade portion of the cutter penetrates through the sheet material W as a workpiece held by the holding member 16 in the thickness-wise direction during the cutting operation. In this state, the feed mechanism moves the sheet material W held by the holding member 16 in the forward and rearward direction, and the cutter transfer mechanism moves the cut head 15, i.e. the cutter, in the left and right direction to perform the cutting operation of the sheet material W. As illustrated in FIG. 1, an X-Y coordinate system including an origin O at the corner on the left rear of the adhesive portion of the holding member 16 is set in the cutting apparatus 11, and the cutting operation is controlled based on cut data indicated by the X-Y coordinate system.

As illustrated in FIG. 2, the cutting apparatus 11 is provided with a control circuit 28 as a control unit. The control circuit 28 is primarily configured by a computer (CPU) and is responsible for the overall control of the cutting apparatus 11. The display 19, the operation switch 20, a RAM 29, and a ROM 30 are connected to the control circuit 28. Drive circuits 31 configured to drive the X-axis motor 25, the Y-axis motor 23, and the Z-axis motor 27, respectively, are also connected to the control circuit 28. A communicating unit 32 configured to communicate with the outside is further connected to the control circuit 28.

Various control programs, such as a cutting control program for controlling the cutting operation, are stored in the ROM 30. Various data and programs including cut data necessary for the cutting operation are stored in the RAM 29. In this case, the communicating unit 32 acquires the cut data from the cut data generating apparatus 1 via the communication cable 10, and the cut data is stored in the RAM 29. The cut data is data indicating cutting positions for cutting the workpiece (sheet material W), and the cut data includes a set of data of coordinate values indicating the cutting positions by the XY coordinate system.

The control circuit 28 executes the cutting control program to control the X-axis motor 25, the Y-axis motor 23, and the Z-axis motor 27 via the drive circuits 31 according to the cut data, respectively, to automatically execute the cutting operation of the sheet material W held by the holding member 16. In this case, the cut data generated by the cut data generating apparatus 1 described later is used, and the cutting apparatus 11 cuts the multiple holes H for placing the rhinestones from the sheet material W to manufacture the pattern sheet.

Next, the cut data generating apparatus 1 according to the present embodiment will be described. As described above, the cut data generating apparatus 1 is configured by a personal computer that executes the cut data generating program. As illustrated in FIG. 1, the cut data generating apparatus 1 includes a displaying unit (liquid crystal display) 2, a keyboard 3, and a mouse 4 on a computer body 1a. As illustrated in FIG. 2, the computer body la is provided with: a control circuit 5 primarily configured by a CPU; and a RAM 6, a ROM 7, an EEPROM 8, a communicating unit 9, etc. connected to the control circuit 5.

The displaying unit 2 is controlled by the control circuit 5 and is configured to display necessary information such as a message for the user. The keyboard 3 and the mouse 4 are operated by the user, and their operation signals are input to the control circuit 5. The RAM 6 temporarily stores necessary information according to the program executed by the control circuit 5. The ROM 7 stores the cut data generating program etc. The EEPROM 8 stores the generated cut data etc. In the present embodiment, the EEPROM 8 functions as a storage unit configured to store data of multiple different figures for which the cut data is to be generated. The user operates the keyboard 3 or the mouse 4 to input the data of a figure desired by the user, and the control circuit 5 acquires the input data of the figure. Therefore, the keyboard 3 and the mouse 4 function as an input operation unit, and the control circuit 5 functions as an acquiring unit.

The communicating unit 9 is configured to transmit and receive data etc. to and from an external device. In the present embodiment, the communicating unit 9 transmits the cut data generated by the cut data generating apparatus 1 to the cutting apparatus 11 via the communication cable 10. The communicating unit 9 of the cut data generating apparatus 1 and the communicating unit 32 of the cutting apparatus 11 may be connected by wireless communication. Although not illustrated, the cut data may be transferred between the cut data generating apparatus 1 and the cutting apparatus 11 via a detachable external storage unit, such as a USB memory, or via a network, such as the Internet.

In the present embodiment, the control circuit 5 uses the software configuration (executes the cut data generating program) to execute each process of the cut data generating apparatus for creating the cut data as described later in the description of the effect (description of flowchart). The cut data generating program may not be stored in advance in the ROM 7. The cut data generating program may be recorded in an external recording medium, such as an optical disk, and may be read from the recording medium.

The cut data is generated by, for example, obtaining one or more lines expressing the figure based on the data of the figure selected by the user from the multiple figures stored in the EEPROM 8 and then setting positions (central positions) of multiple holes H on each line based on the line data. The “lines” here denote lines that form the figure and denote lines including end points on opposite ends. The lines include straight lines, curved lines, and bent lines. In other words, the “lines” here denote lines that can be depicted with a single stroke. The “figure” here denotes a figure in a shape expressed by one or multiple lines.

In this case, when the control circuit 5 generates the cut data, the user operates the keyboard 3 or the mouse 4 to input the size of the holes H (for example, radial dimension R) and the distance between two holes H (for example, length A of the interval between the holes H) in the present embodiment. It is obvious that the size of the holes H corresponds to the size of the rhinestones to be used. The distance between two holes H can be determined by the density of the placement of the rhinestones desired by the user. The control circuit 5 generates the cut data based on the input size of the holes H and the distance between two adjacent holes H.

More specifically, the control circuit 5 generates the cut data as follows in the present embodiment. The control circuit 5 first extracts, as a first feature point and a second feature point, end points on opposite ends of a target line that is a line to be focused among the one or more lines expressing the figure. The control circuit 5 basically sets third feature points on the target line between the first feature point and the second feature point based on the input distance such that the feature points are lined up at substantially equal intervals. The control circuit 5 places the hole H on each position of the first feature point, the second feature point, and the third feature points and generates the cut data for cutting the placed holes H based on the input size of the holes H. Therefore, the control circuit 5 functions as an extracting unit, a setting unit, a placing unit, and a cut data generating unit.

In the present embodiment, the control circuit 5 also judges whether or not the target line has a corner bent at an angle equal to or smaller than a predetermined angle (for example, 70°) before setting the third feature points. When there is a corner bent at an angle equal to or smaller than the predetermined angle, the control circuit 5 extracts, as a fourth feature point, the apex of the corner. In this case, the control circuit 5 sets the third feature points on the target line between the first feature point and the fourth feature point and on the target line between the second feature point and the fourth feature point such that the feature points are lined up at substantially equal intervals. The control circuit 5 places the hole on each position of all feature points.

In the present embodiment, the control circuit 5 further detects whether or not there is a cross point on the target line or between the target line and another line of the figure. When a cross point is detected at a position that is not the end point of the target line, the control circuit 5 extracts, as a fifth feature point, the cross point of the target line. In this case, the control circuit 5 sets the third feature points on the target line between the first feature point and the second feature point such that the feature points including the fifth feature point are lined up at substantially equal intervals. The control circuit 5 places the hole on each position of all feature points.

In the present embodiment, when a corner bent at an angle equal to or smaller than the predetermined angle is judged to exist and a cross point is detected at a position on the target line that is not the end point, the control circuit 5 extracts, as a fourth feature point, the apex of the corner and extracts, as a fifth feature point, the cross point of the target line. The control circuit 5 sets the third feature points on the target line between the first feature point and the second feature point such that the feature points including the fourth feature point and the fifth feature point are lined up at substantially equal intervals. The control circuit 5 places the hole on each position of all feature points.

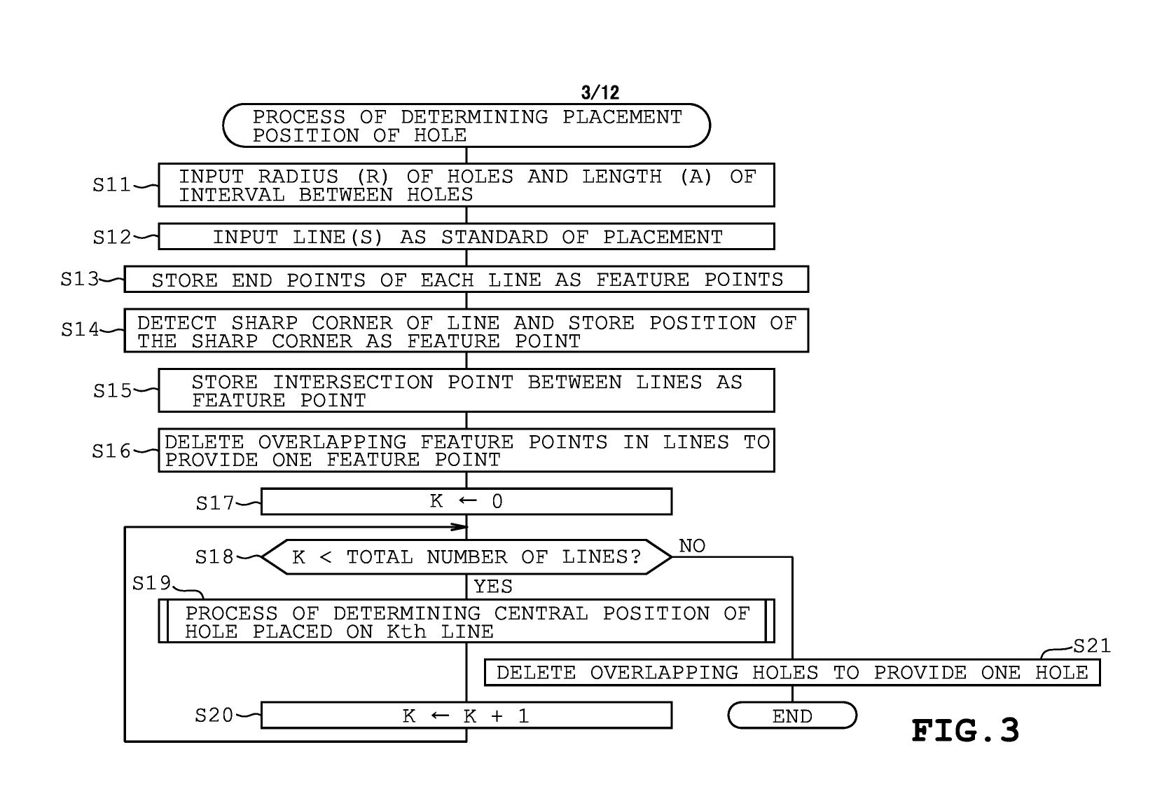

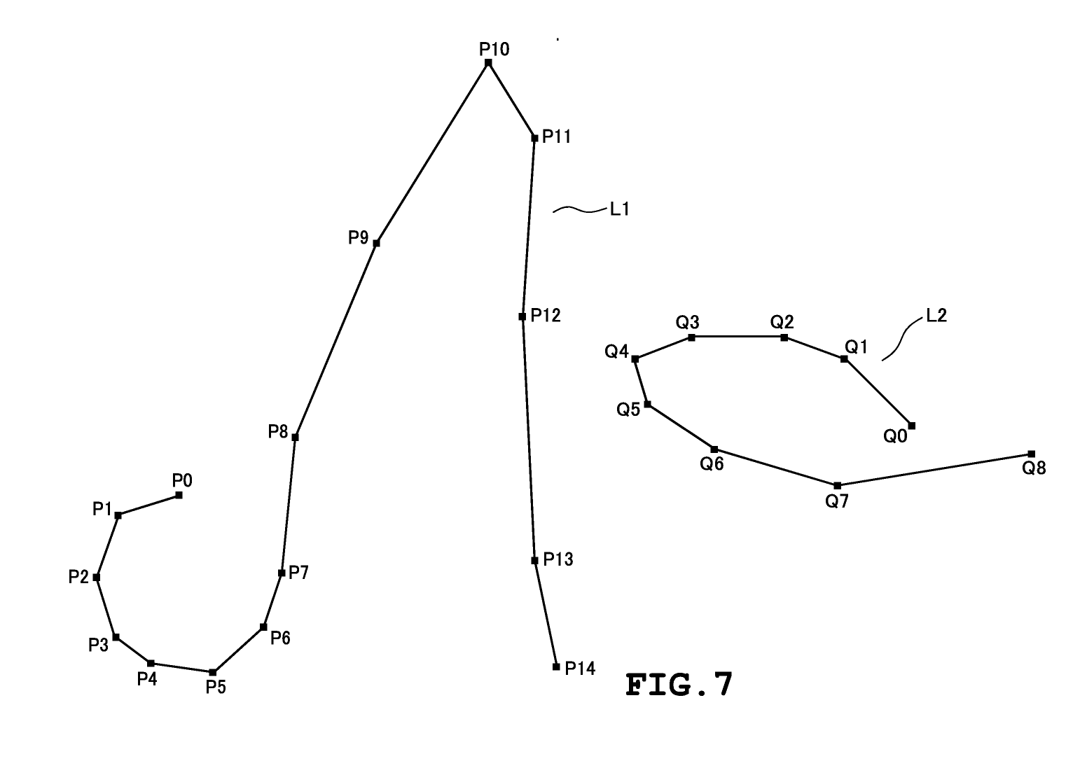

Next, an effect of the structure as described above will be described with reference also to FIGS. 3 to 11. In a specific example described here, cut data for cutting holes for placing the rhinestones is generated for a figure F indicating, for example, a letter “A” as shown in FIG. 6 etc. In this case, the line expressing the figure F shown in FIG. 6 can be divided into two lines L1 and L2 illustrated in FIG. 7. The lines L1 and L2 will be called a first line L1 and a second line L2 when a distinction is made between the lines L1 and L2.

In this case, the data of each of the lines L1 and L2 includes a set of position coordinates of multiple configuration points included in each of the lines L1 and L2. The configuration points include opposite end points and connection points sequentially connecting straight lines from one end point to the other end point when each of the lines L1 and L2 is approximated to consecutive straight line segments. As illustrated in FIGS. 6 and 7, the configuration points of the first line L1 include points P0, P1, P2, P3, P4, P5, P6, P7, P8, P9, P10, P11, P12, P13, and P14. The configuration points of the second line L2 include points Q0, Q1, Q2, Q3, Q4, Q5, Q6, Q7, and Q8.

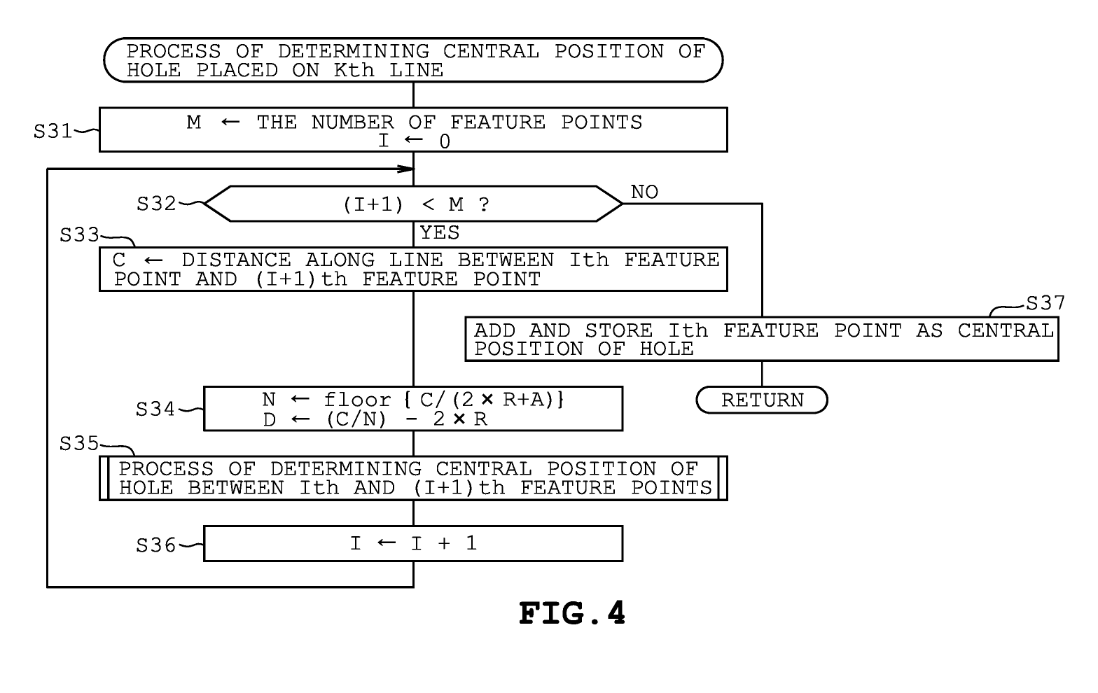

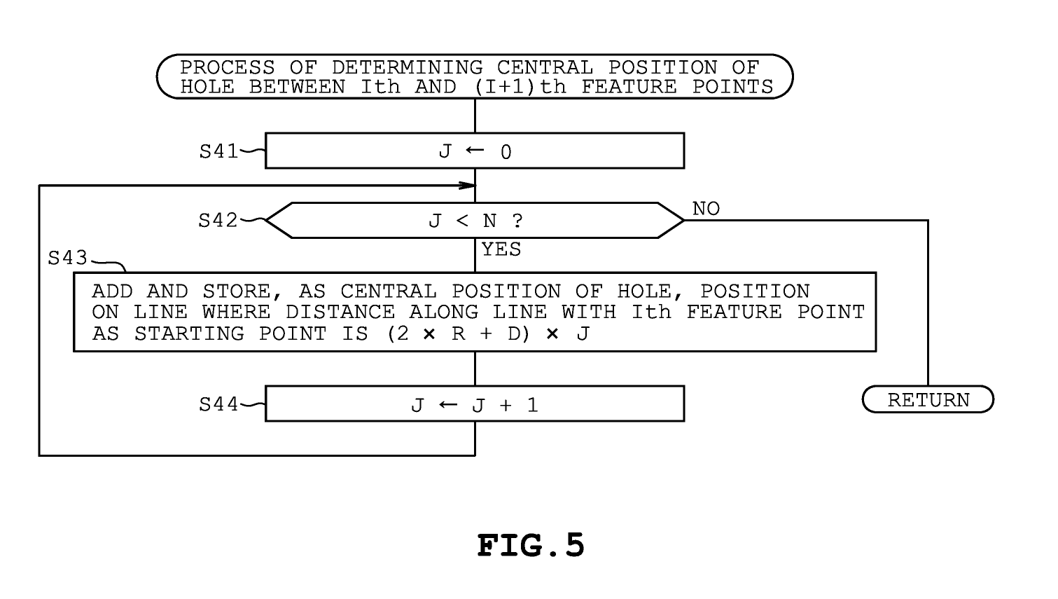

As described above, the control circuit 5 extracts and sets multiple feature points on each of the lines L1 and L2 based on the data of each of the lines L1 and L2 expressing the figure F and places the holes H on the feature points to generate the cut data. Flowcharts of FIGS. 3 to 5 illustrate procedures of processes executed by the control circuit 5 in this case. Among the flowcharts, the flowchart of FIG. 3 illustrates a main routine for determining the positions of the holes H. The flowchart of FIG. 4 illustrates a detailed procedure of a process (step S19) of determining the positions for placing the holes H on a target line (Kth line) in FIG. 3. The flowchart of FIG. 5 illustrates a detailed procedure of a process (step S35) of determining central positions of the holes H in FIG. 4.

More specifically, as illustrated in FIG. 3, the user first inputs the radius R (for example, 1 to 2 mm) of the holes H for placing the rhinestones and the length dimension A (for example, 1 to 3 mm) of the intervals between the holes H in step S11. As a result, the control circuit 5 acquires the input radius R of the holes H and the length dimension A of the intervals. The data of each of the lines L1 and L2 are input in next step S12. As a result, the control circuit 5 acquires the input data of each of the lines L1 and L2. To input the data of the lines, the user may select the data from the multiple figures stored in the EEPROM 8, or the user may set the each of lines L1 and L2 (specify the configuration points) of the figure F on a screen of the displaying unit 2.

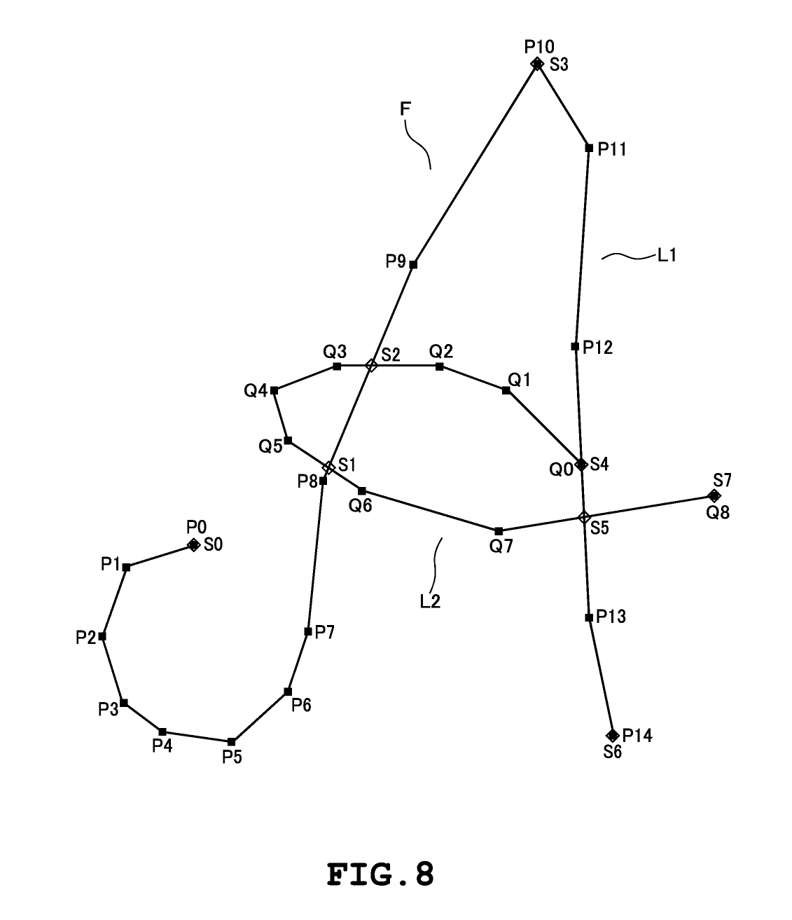

A process of extracting the first, second, fourth, and fifth feature points from each of the lines L1 and L2 is executed from steps S13 to S16. Although not illustrated in detail, one line is set as a target line, and the process of extraction is executed for each target line. That is, the extraction process is applied to all of the lines L1 and L2. In step S13, opposite end points in each of the lines L1 and L2 are extracted as the first feature point and the second feature point. In the examples of FIGS. 6 and 7, the point P0 and the point P14 are set as a first feature point S0 and a second feature point S6 (see FIG. 8) for the first line L1. The point Q0 and the point Q8 are set as a first feature point S4 and a second feature point S7 (see FIG. 8) for the second line L2.

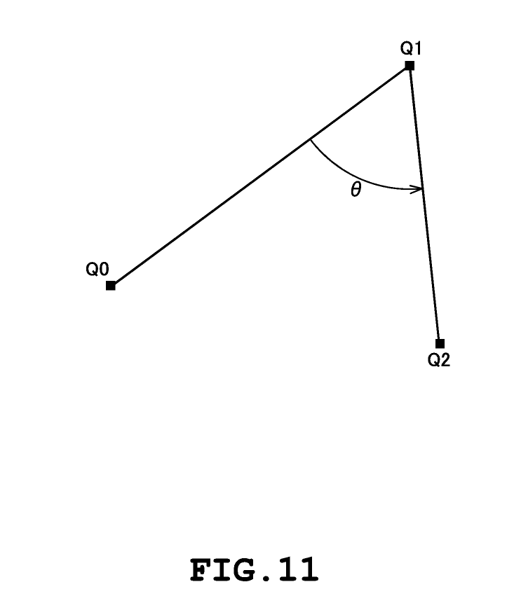

In step S14, whether or not there is a sharp corner bent at an angle equal to or smaller than the predetermined angle (for example, 70°) is judged for each of the lines L1 and L2. When there is a sharp corner, the apex of the corner is extracted as a fourth feature point. For the judgement of the sharp corner, three consecutive configuration points are extracted as illustrated in FIG. 11. A smaller angle θ (equal to or smaller than 180°) of the corner with the apex at the center configuration point is calculated, and whether or not the angle θ is equal to or smaller than 70° is judged. In the examples of FIGS. 6 and 7, the point P10 of the first line L1 is extracted as the apex of a sharp corner, and the point P10 is set as a fourth feature point S3 (see FIG. 8). In the second line L2, it is judged that there is no sharp corner equal to or smaller than the predetermined angle.

In step S15, whether or not there is a cross point on the target line or between the target line and another line in each of the lines L1 and L2 is detected. When there is a cross point, the cross point is extracted as a fifth feature point. A publicly known technique can be used to detect the cross point, and the details will not be described. In the examples of FIGS. 6 and 7, the straight line connecting the points P8 and P9 of the first line L1 crosses the straight line connecting the points Q5 and Q6 of the second line, and the straight line connecting the points P8 and P9 of the first line L1 crosses the straight line connecting the points Q2 and Q3 of the second line. The straight line connecting the points P12 and P13 of the first line L1 crosses the point Q0 of the second line (the point Q0 is on the first line L1), and the straight line connecting the points P12 and P13 of the first line L1 crosses the straight line connecting the points Q7 and Q8 of the second line. These cross points are sequentially set as fifth feature points S1, S2, S4, and S5 (see FIG. 8).

In step S16, if there are overlapping feature points among the first, second, fourth, and fifth feature points in each of the lines L1 and L2, the overlapping feature points are deleted to provide one feature point. A publicly known technique can be used to detect the overlapping points, and the details will not be described. In the example of FIG. 8, the first feature point S4 as an end point and the fifth feature point S4 that is one of the cross points overlap in the second line L2, and thus one of the feature points is deleted.

In step S17, 0 is set in a variable K indicating the number of the line. In next step S18, whether or not the value of the variable K is smaller than the total number of lines (2 in this case) is judged. If the value of the variable K is smaller than the total number of lines (Yes in step S18), a process of determining the positions (central positions) of the holes H for the Kth line is executed in step S19. Details of the process of step S19 will be described in the explanation of the flowchart of FIG. 4. When the process of determining the positions of the holes H for the Kth line is executed, the value of the variable K is incremented by 1 in step S20, and the process returns to step S18.

Here, the process of determining the positions of the holes H for one line (Kth target line) illustrated in the flowchart of FIG. 4 will be described. In step S31, the number of feature points already extracted in the target line is set in a variable M, and 0 is set in a variable I for indicating the number of the feature point in the target line. In the example of FIG. 8, the first line L1 includes the feature points S0, S1, S2, S3, S4, S5, and S6, and the number of feature points is six. The second line L2 includes the feature points S4, S2, S1, S5, and S7, and the number of feature points is five. In step S32, whether or not (I+1) is smaller than M is judged, and if (I+1) is still smaller than M (Yes in step S32), the process proceeds to step S33.

In steps S33 to S35, a process of setting the third feature points between the Ith feature point and the (I+1)th feature point is executed. In step S33, the distance along the target line between the Ith feature point and the (I+1)th feature point is obtained, and the distance is set in a variable C indicating the distance. In step S34, floor{C/(2×R+A)} is calculated and set in a variable N indicating the number of partitions, and (C/N)−2×R is calculated and set in a variable D (adjusted dimension D) indicating the length of the intervals between the holes H. In this case, the function of Y=floor(X) denotes that the decimal places of X are cut off to obtain an integer, and the value is set in Y.

In step S35, the positions (central positions) of the holes H along the target line between the Ith feature point and the (I+1)th feature point are determined. Details of the process are as illustrated in the flowchart of FIG. 5. First, 0 is set in a variable J in step S41. In step S42, whether or not the value of the variable J is smaller than the number of partitions N is judged. If the variable J is smaller than the number of partitions N (Yes in step S42), the third feature point is added and stored in step S43 such that the position where the distance from the Ith feature point along the target line is (2×R+D)×J is the central position of the hole H.

Subsequently, the value of the variable J is incremented by 1 in step S44, and the process returns to step S42. The process of steps S42 to S44 is repeated until the variable J is equal to the number of partitions N. When the variable J is equal to the number of partitions N (No in step S42), the process returns to the flowchart of FIG. 4.

In FIG. 4, when the process of step S35 is finished, the value of the variable I is incremented by 1 in step S36, and the process returns to step S32. The process of steps S32 to S36 is repeated until the value of (I+1) is equal to M. When the value of (I+1) is equal to M (No in step S32), the Ith feature point, that is, the final feature point in the target line, is added and stored in step S37 such that the final feature point is the central position of the hole H, and the process returns to the flowchart of FIG. 3.

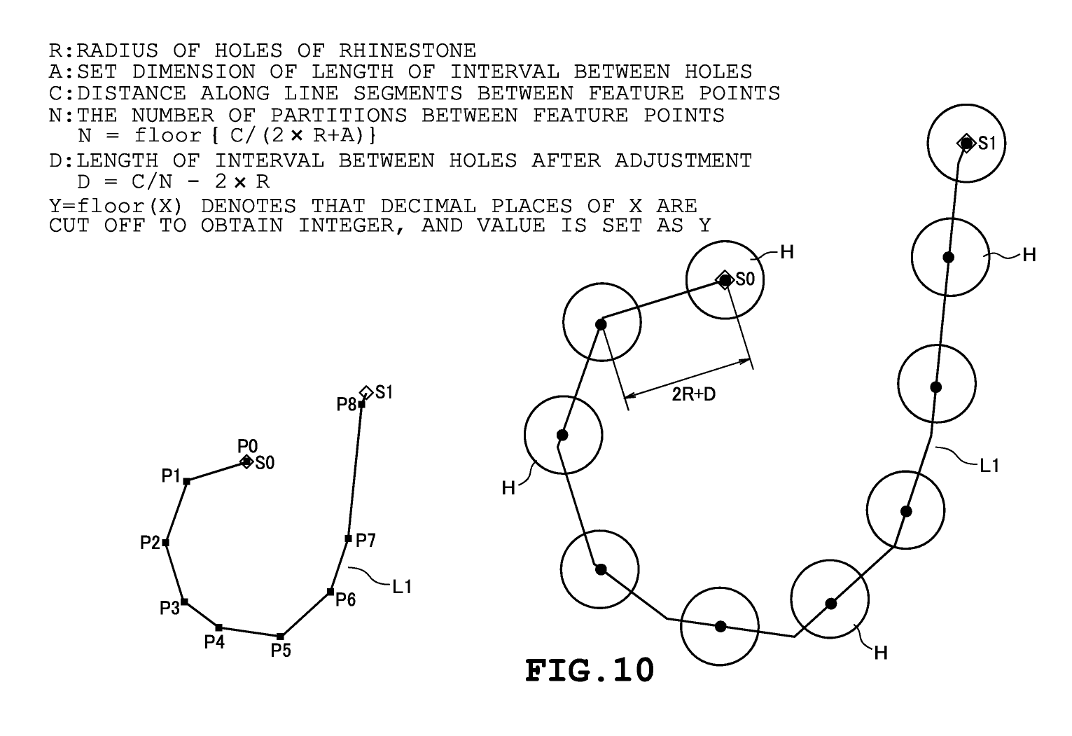

A specific example of the process of setting the third feature points as described above will be described here with reference to FIG. 10. FIG. 10 illustrates the line from the feature point S0 to the feature point S1 of the first line L1 extracted from the example of FIG. 8. As described above, the radius R of the holes H for placing the rhinestones and the length dimension A of the intervals between the holes H are already set. As illustrated in (a) of FIG. 10, the distance C along the target line from the Ith feature point S0 to the (I+1)th feature point S1 is the distance from the feature point SO to the configuration point P1+the distance from the configuration point P1 to the configuration point P2+the distance from the configuration point P2 to the configuration point P3+the distance from the configuration point P3 to the configuration point P4+the distance from the configuration point P4 to the configuration point P5+the distance from the configuration point P5 to the configuration point P6+the distance from the configuration point P6 to the configuration point P7+the distance from the configuration point P7 to the configuration point P8+the distance from the configuration point P8 to the feature point S1.

The variable N denotes the number of partitions from the feature point S0 to the feature point S1 (the number of intervals between the holes H) and is calculated by N=floor{C/(2×R+A)}. In the example of FIG. 10, the number of partitions N is nine, for example. The value of the adjusted dimension D that is substantially the interval between the holes H can be obtained by D=(C/N)−2×R. In (b) of FIG. 10, the third feature points are set, and the holes H with the radial dimension R are placed on the target line from the feature point S0 to the feature point S1. The centers of multiple holes H are set such that the centers are lined up at equal intervals (D+2×R) along the target line.

Returning to the flowchart of FIG. 3, when the process of step S19 is finished, the value of the variable K is incremented by 1 in step S20, and the process returns to step S18. The process of steps S18 to S20 is repeated until the value of the variable K is equal to the total number of lines. When the value of the variable K is equal to the total number of lines after the end of the placement of the holes H for all lines (No in step S18), a process of deleting the positions of overlapping holes H among the lines (including the positions of the partially overlapping holes H) to provide one position is executed in step S21. The overlapping of the holes H here can be judged based on, for example, the central position and the radius of each hole H. The process ends after the execution of the process of step S21. Although not illustrated, the cut data for cutting the holes H from the sheet material W is generated after the determination of the locations of the holes H as described above.

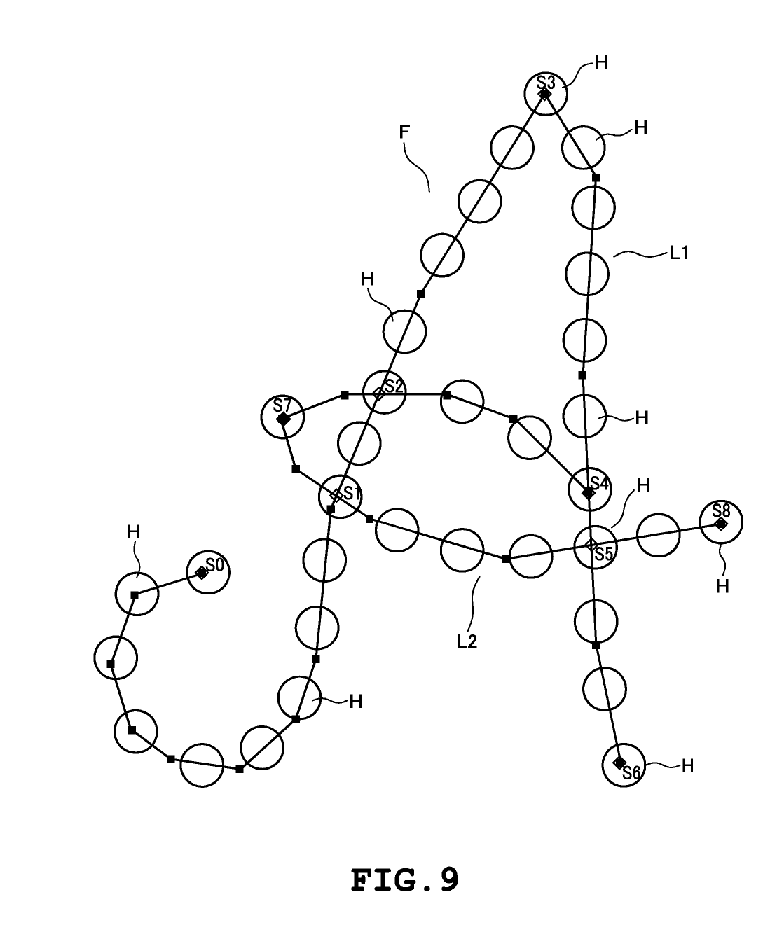

In the example of the figure F of FIG. 6, the positions of the holes H are determined as illustrated in FIG. 9. In this way, the holes H (first feature point and second feature point) are placed on the end points of each of the lines L1 and L2 expressing the figure F. The hole H (fourth feature point) is placed at the apex of the acute corner in each of the lines L1 and L2. The holes H (fifth feature points) are placed at the cross point parts of each of the lines L1 and L2. The holes H (third feature points) are placed on the lines L1 and L2 between the first feature points, the second feature points, the fourth feature points, and the fifth feature points such that the holes H are lined up at substantially equal intervals.

As a result, the holes H can be placed on the positions of the first feature points, the second feature points, the fourth feature points, and the fifth feature points that are characteristic points of the lines L1 and L2 in expressing the figure F. The holes H can also be placed on the positions of multiple third feature points. As a result, the rhinestone can be placed on each of the holes H to favorably express the shapes of the lines L1 and L2. That is, the holes H can be placed such that the features of the figure F can be sufficiently expressed by multiple rhinestones.

In this way, according to the present embodiment, the holes H are at least placed by setting, as the first feature point and the second feature point, the end points of each of the lines L1 and L2 expressing the figure F, and the holes H are placed by setting the third feature points on the lines L1 and L2 between the feature points. This attains an excellent advantageous effect of generating the cut data in which the holes H are placed to allow the features of the figure F to be sufficiently expressed. In this case, the third feature points are set such that the feature points are lined up at substantially equal intervals on the lines L1 and L2 between the first feature points and the second feature points. Therefore, the shapes of the lines L1 and L2 can be favorably expressed.

Particularly, when the lines L1 and L2 have an acute corner, the fourth feature point is set at the apex of the corner to place the hole H in the present embodiment. When there is a cross point in the lines L1 and L2, the fifth feature point is set at the cross point to place the hole H. As a result, the shape of the figure F can be more favorably expressed.

Furthermore, the user can input and set the size (radius R) of the holes H and the distance between two adjacent holes H (length of the interval between two holes H) in the embodiment. Therefore, cut data that allows rhinestones to be placed in a wide variety of locations according to the preference of the user can be generated. In the present embodiment, multiple different figures are stored in the EEPROM 8, and the user can acquire the figure F for generating the cut data among the figures. Therefore, the user can select the desired figure F, and cut data appropriate for expressing the figure F can be generated.

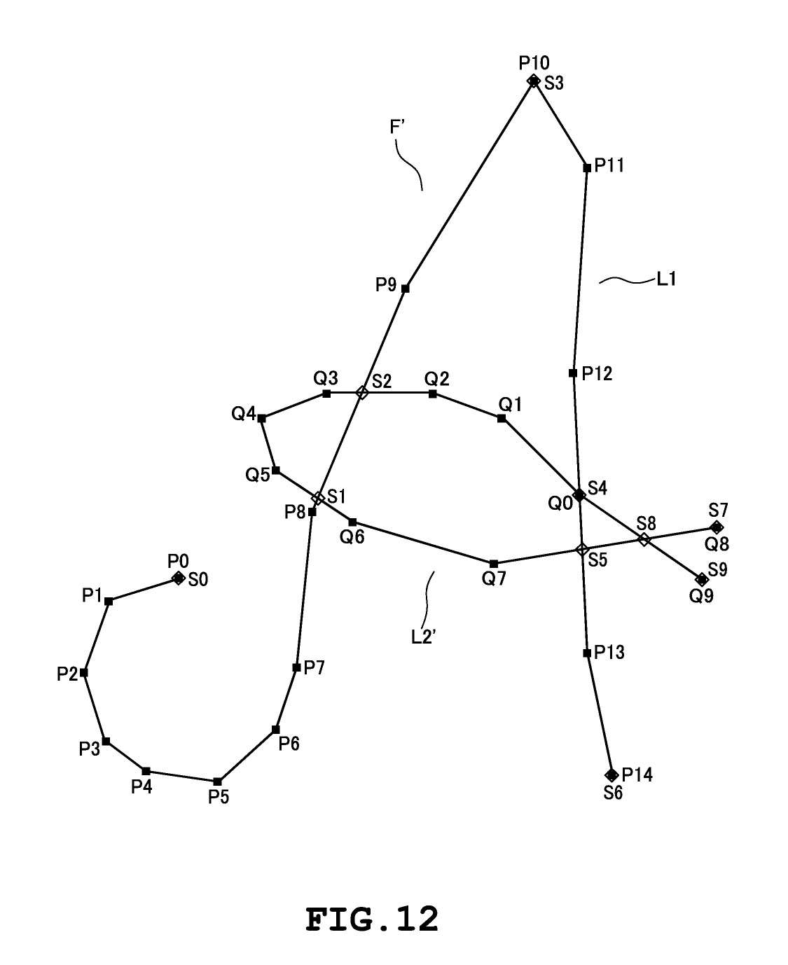

FIG. 12 illustrates another embodiment of the disclosure. The embodiment of FIG. 12 illustrates a case in which a cross point exists in a line L2′ of the line L1 and the line L2′ included in the figure F′. More specifically, the line L2′ includes configuration points Q9, Q0, Q1, Q2, Q3, Q4, Q5, Q6, Q7, and Q8, and a line connecting the configuration points Q9 and Q0 and a line connecting the configuration points Q7 and Q8 cross each other. In this case, the cross point is set as a fifth feature point S8, and the hole H is placed. The configuration point Q9 that is an end point is set as a first feature point S9, and the hole H is placed.

Although the cut data generating apparatus 1 is configured by a personal computer in the embodiments as described above, the cut data generating apparatus 1 may be configured as an apparatus dedicated to the generation of the cut data. The cutting apparatus 11 may be configured to have the functions of the cut data generating apparatus. In this case, a scanner configured to read data of a figure from an original drawing may be included. Furthermore, the specific structure of the cutting apparatus can be changed in various ways. The disclosure is not limited to the embodiments as described above, and the disclosure can be appropriately changed and carried out without departing from the scope of the disclosure.

In the embodiments described above, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

We claim:

1. A cut data generating apparatus configured to generate cut data for a cutting apparatus to cut multiple holes from a sheet material, the cut data generating apparatus comprising:
a controller,
the controller being configured to control the cut data generating apparatus to:
extract, as a first feature point and a second feature point, end points on opposite ends of one line in a figure expressed by one or more lines with finite lengths;
set third feature points on the one line between the first feature point and the second feature point;
place a hole on each position of the first feature point, the second feature point, and the third feature points; and
generate cut data for cutting the placed holes.

2. The cut data generating apparatus according to claim 1,
the controller being configured to further control the cut data generating apparatus to:
set the third feature points such that the feature points are lined up at equal intervals on the one line between the first feature point and the second feature point.

3. The cut data generating apparatus according to claim 2,
the controller being configured to further control the cut data generating apparatus to:
determine whether a corner bent at an angle equal to or smaller than a predetermined angle exists on the one line,
extract, as a fourth feature point, an apex of the corner in response to determining that the corner bent at the angle equal to or smaller than the predetermined angle exists,
set the third feature points on the one line between the first feature point and the fourth feature point and on the one line between the second feature point and the fourth feature point such that the feature points are lined up at equal intervals, and
place a hole on the fourth feature point.

4. The cut data generating apparatus according to claim 2,
the controller being configured to further control the cut data generating apparatus to:
determine whether a cross point exists on the one line or between the one line and another line of the figure,
extract, as a fifth feature point, the cross point of the one line in response to determining that the cross point exists on the one line or between the one line and another line of the figure,
set the third feature points on the one line between the first feature point and the second feature point such that the feature points including the fifth feature point are lined up at equal intervals, and
place a hole on the fifth feature point.

5. The cut data generating apparatus according to claim 2,
the controller being configured to further control the cut data generating apparatus to:
determine whether a corner bent at an angle equal to or smaller than a predetermined angle exists on the one line; and
determine whether a cross point exists on the one line or between the one line and another line of the figure,
extract, as a fourth feature point, an apex of the corner and extract, as a fifth feature point, the one line cross point in response to determining that the corner bent at the angle equal to or smaller than the predetermined angle exists, and in response to determining that the cross point exists on the one line or between the one line and another line of the figure,
set the third feature points on the one line between the first feature point and the second feature point such that the feature points including the fourth feature point and the fifth feature point are lined up at equal intervals, and
place a hole on the fourth feature point and the fifth feature point respectively.

6. The cut data generating apparatus according to claim 2,
the controller being configured to further control the cut data generating apparatus to:
input a size of the hole and a distance between two adjacent holes,
set the third feature points based on the input size of the hole and the input distance between two adjacent holes.

7. The cut data generating apparatus according to claim 1, further comprising
a storage configured to store multiple different figures; and
the controller being configured to further control the cut data generating apparatus to:
acquire a figure from the figures stored in the storage.

8. The cut data generating apparatus according to claim 1,
wherein the figure is expressed by at least two lines with finite lengths including the one line,
the controller being configured to further control the cut data generating apparatus to:
extract the end points as the first feature point and the second feature point in each of the at least two lines,
set the third feature points in each of the at least two lines, and
place the only one of overlapping holes when one of the holes placed on the set feature points on the one line overlaps with one of the holes placed on the set feature points on another line.

9. A cutting apparatus comprising:
a cutter;
a holding member configured to hold a sheet material;
a feed mechanism configured to feed the holding member;
a cutter transfer mechanism configured to move the cutter; and
a controller,
the controller being configured to control the cutting apparatus to:
extract, as a first feature point and a second feature point, end points on opposite ends of one line in a figure expressed by one or more lines with finite lengths;
set third feature points on the one line between the first feature point and the second feature point;
place a hole on each position of the first feature point, the second feature point, and the third feature points; and
generate cut data for cutting the placed holes.

10. A non-transitory computer-readable recording medium storing instructions for a computer which has a controller,
the instructions cause, when executed by the controller, the computer to:
extract, as a first feature point and a second feature point, end points on opposite ends of one line in a figure expressed by one or more lines with finite lengths;
set third feature points on the one line between the first feature point and the second feature point;
place a hole on each position of the first feature point, the second feature point, and the third feature points; and
generate cut data for cutting the placed holes.
